(19) United States
(12) Patent Application Publication
(10) Pub. No.: US 2017/0072546 A1
(43) Pub. Date: Mar. 16, 2017

(54) All-in-one battery maintenance device

(71) Applicant: Robert Edmonds, Woodbridge, VA (US)

(72) Inventor: Robert Edmonds, Woodbridge, VA (US)

(21) Appl. No.: 15/263,358

(22) Filed: Sep. 12, 2016

Related U.S. Application Data
(60) Provisional application No. 62/217,054, filed on Sep. 11, 2015.

(51) Int. Cl. B25B 27/00; A46B 15/00; A46B 9/02; A46B 5/00; B25F 1/04; B25B 13/04

(52) U.S. Cl. CPC B25B 27/0042; B25F 1/04; B25B 13/04; A46B 9/026; A46B 5/0033; A46B 15/0091

(57) ABSTRACT

A wire brush, a side-post wrench, and a top-post wrench which are capable of pivoting coaxially around the upper end of the device to be concealed within the handle comprises an all-in-one battery maintenance device. The lower end provides a heavy, solid base which may be safely used to tap the battery cables into the proper position on the posts of a top-post battery.

### CROSS-REFERENCE TO RELATED APPLICATIONS

This Application claims the benefit of U.S. Provisional Application No. 62/217,054, filed Sep. 11, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to hand tools and in particular to an all-in-one battery maintenance device. Large batteries are an essential component of vehicles of all types, as well as riding lawnmowers, motorcycles, tractors, power boats, forklifts, and a broad variety of other types of powered equipment. These batteries require regular maintenance to remove corrosion and keep them in good working order. Unfortunately, this maintenance is performed with an assortment of small tools that are easily dropped and lost. An all-in-one battery maintenance device, which provides a stainless steel wire brush and wrenches for both top-post and side-post batteries, would resolve this problem.

### SUMMARY OF THE INVENTION

Accordingly, the invention is directed to an all-in-one battery maintenance device. The device is configured in a manner similar to a pocketknife, providing a wire brush, a side-post wrench, and a top-post wrench which are capable of pivoting coaxially around the upper end of the device to be concealed within the handle. The lower end provides a heavy, solid base which may be safely used to tap the battery cables into the proper position on the posts of a top-post battery.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a front view of the first exemplary embodiment with the wire brush extended, displaying the device 10, the cover 11, the wire brush 12, and the base 15.

FIG. 2 is a front view of the first exemplary embodiment with the side-post wrench extended, displaying the device 10, the cover 11, the side-post wrench 13, and the base 15.

FIG. 3 is a front view of the first exemplary embodiment with the top-post wrench extended, displaying the device 10, the cover 11, the top-post wrench 14, and the base 15.

FIG. 4 is a front view of the first exemplary embodiment, displaying the device 10, the cover 11, and the base 15.

FIG. 5 is a front view of the first exemplary embodiment with the cover removed, displaying the device 10, the cover 11 the wire brush 12, the side-post wrench 13, the top-post wrench 14, the base 15, and the handle 16.

FIG. 6 is a front perspective view of the first exemplary embodiment with the cover removed, displaying the device 10, the cover 11 the wire brush 12, the side-post wrench 13, the top-post wrench 14, the base 15, and the handle 16.

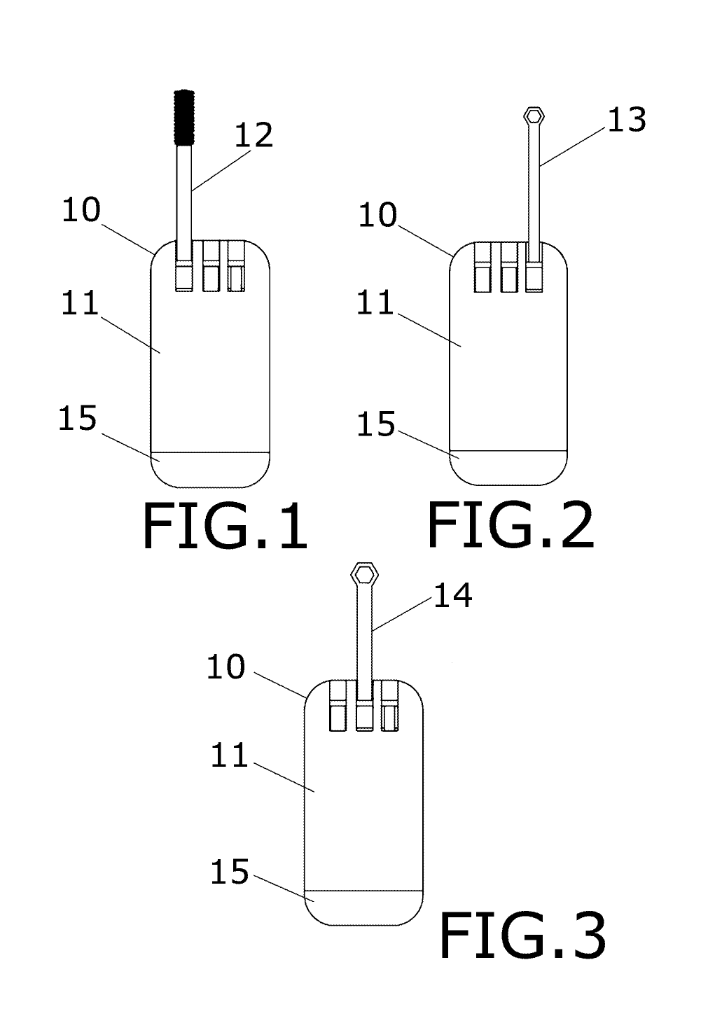

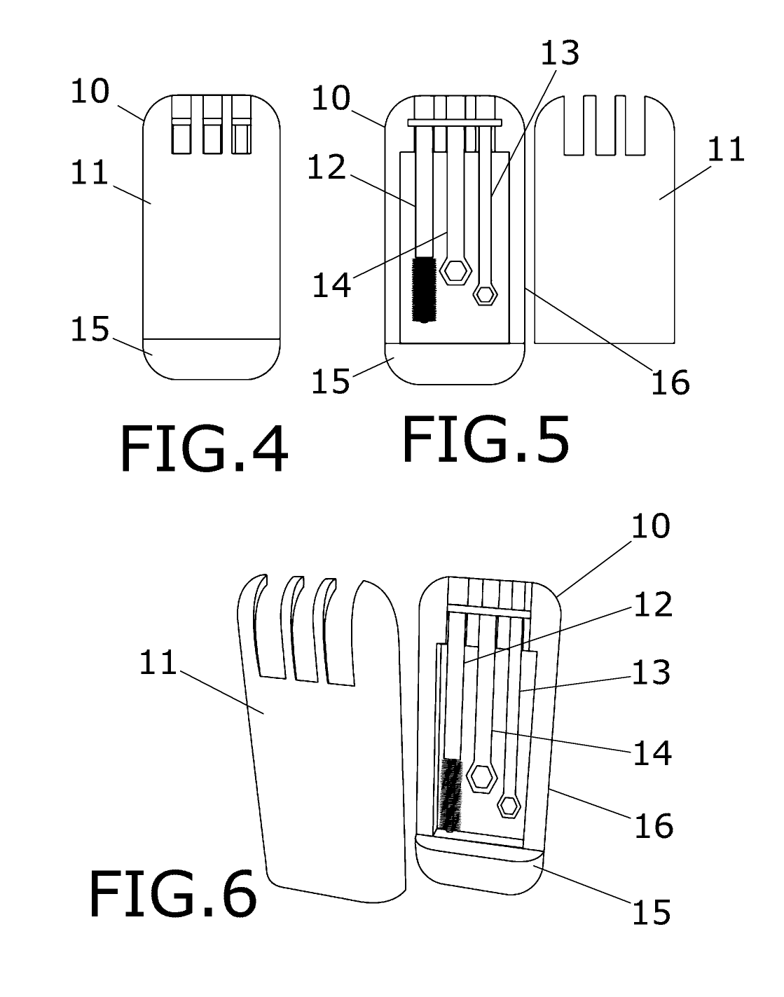

### DETAILED DESCRIPTION OF THE INVENTION

Referring now to the invention in more detail, the invention is directed to an all-in-one battery maintenance device 10.

The first exemplary embodiment is comprised of a device 10 which is configured in a manner similar to a pocketknife, providing a wire brush 12, a side-post wrench 13, and a top-post wrench 14 which are capable of pivoting coaxially around the upper end of the device to be concealed within the handle 16. The lower end provides a heavy, solid base 15 which may be safely used to tap the battery cables into the proper position on the posts of a top-post battery.

A snap-on cover 11 is provided which covers and protects the wire brush 12, the side-post wrench 13, and the top-post wrench 14, keeping the interior of the device 10 clean and free from debris. Alternate embodiments providing one or more additional tools, which are mounted coaxially with the wire brush 12, the side-post wrench 13, and the top-post wrench 14, and may be concealed within the handle 16, are contemplated.

To use the first exemplary embodiment, the user may remove the cover 11, and may extend the side-post wrench 13 or the top-post wrench 14 as appropriate, to remove the battery cables. Upon removing the battery cables, the user then folds the wrench into the handle 16 and may extend the wire brush 12 to clean corrosion from the battery posts. Upon cleaning off the corrosion, the user then folds the wire brush 12 into the handle 16 and may extend the side-post wrench 13 or the top-post wrench 14 as appropriate, to replace the battery cables and ensure that they are tightly affixed to the posts. If the battery is a top-post battery, the user may then use the base 15 to gently tap the battery cables into position on the posts.

The cover 11 is preferably manufactured from a rigid, durable material, such as plastic or aluminum alloy. The wire brush 12, the side-post wrench 13, the top-post wrench 14, the base 15, and the handle 16 are preferably manufactured from a rigid, durable material which is corrosion resistant, such as stainless steel.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An all-in-one batter maintenance device comprising:
a. a handle;
b. said handle being hollow;
c. a plurality of tools being mounted within the handle such that the tools can be pivoted coaxially around an upper end of the tool;
d. said plurality of tools including any one or more of a wire brush, a side-post wrench, a top-post wrench.
